(19) United States
(12) Patent Application Publication
(10) Pub. No.: US 2025/0308380 A1
(43) Pub. Date: Oct. 2, 2025

(54) APPROACH MONITORING SYSTEM, APPROACH MONITORING METHOD, AND STORAGE MEDIUM

(71) Applicant: HONDA MOTOR CO., LTD., Tokyo (JP)

(72) Inventors: Takashi Oshima, Wako-shi (JP); Seiji Kobata, Wako-shi (JP)

(21) Appl. No.: 19/020,251

(22) Filed: Jan. 14, 2025

(30) Foreign Application Priority Data
Mar. 29, 2024 (JP) 2024-055487

(51) Int. Cl. G08G 1/005

(52) U.S. Cl. CPC G08G 1/005

(57) ABSTRACT

An approach monitoring system for detecting a moving person present in a periphery of a vehicle, for recognizing a vehicle prediction route, for recognizing a moving person prediction route, for calculating a closest approach distance in the vehicle prediction route and the moving person prediction route in a case where the vehicle prediction route and the moving person prediction route do not overlap, the closest approach distance being a distance between the vehicle and the moving person at a closest approach time being a time when the vehicle and the moving person are predicted to be at a closest approach, and for performing attention calling to the moving person at a time when the closest approach distance is equal to or less than a predetermined judgment distance.

### INCORPORATION BY REFERENCE

The present application claims priority under 35 U.S.C. § 119 to Japanese Patent Application No. 2024-055487 filed on Mar. 29, 2024. The content of the application is incorporated herein by reference in its entirety.

### BACKGROUND OF THE INVENTION

### Field of the Invention

The present invention relates to an approach monitoring system, an approach monitoring method, and a storage medium.

### Description of the Related Art

In recent years, efforts have become more active to provide access to a sustainable transportation system that takes into consideration people who are in a vulnerable position from among traffic participants. There has been a focus on research and development that further improves the safety and convenience of traffic through research and development related to preventive safety technology directed towards implementation of these efforts.

For example, Japanese Patent Laid-Open No. 2006-31443 discloses technology that notifies a collision avoidance message to a pedestrian, by judging that there is a collision possibility of a vehicle and the pedestrian, at the time when there is a possibility of the vehicle and the pedestrian being present at a same point at a same time, based on a prediction route of the vehicle and a prediction route of the pedestrian.

Incidentally, in preventive safety technology, it is desirable to prevent in advance a pedestrian present in a periphery of a vehicle from making contact with the vehicle. However, in the technology of Japanese Patent Laid-Open No. 2006-31443, since a message of collision avoidance is not notified in a case where a prediction route of the vehicle and a prediction route of the pedestrian do not overlap, a response to a sudden change in behavior of the pedestrian cannot be performed, the sudden change in behavior being the pedestrian jumping out onto a roadway or the like. Moreover, while it can be considered that a condition for performing a response of contact avoidance is alleviated, by increasing a margin of contact avoidance, in this case, there is a fear that the pedestrian feels annoyance, by having attention calling for contact avoidance frequently performed in a situation where the possibility of contact is low. Accordingly, a problem of the present application is to prevent in advance contact between a vehicle and a moving person while suppressing a feeling of annoyance by the moving person, the contact between the vehicle and the moving person being due to a sudden change in behavior of the moving person walking in a periphery of the vehicle or the moving person moving to board an automobile or the like.

In order to solve this problem, the present application has an objective to provide an approach monitoring system, an approach monitoring method, and a non-transitory computer-readable storage medium storing an approach monitoring program that can prevent in advance contact between a vehicle and a moving person, while suppressing a feeling of annoyance by the moving person, the contact between the vehicle and the moving person being due to a sudden change in behavior of the moving person present in a periphery of the vehicle. Also, by extension, the present application contributes to the development of sustainable transportation systems.

### SUMMARY OF THE INVENTION

As a first aspect for achieving this objective, an approach monitoring system is provided, the approach monitoring system including a moving person detection unit for detecting a moving person present in a periphery of a vehicle, a vehicle prediction route recognition unit for recognizing a vehicle prediction route being a prediction route of the vehicle, a moving person prediction route recognition unit for recognizing a moving person prediction route being a prediction route of the moving person, a closest approach distance calculation unit for calculating a closest approach distance in the vehicle prediction route and the moving person prediction route in a case where the vehicle prediction route and the moving person prediction route do not overlap, the closest approach distance being a distance between the vehicle and the moving person at a closest approach time being a time when the vehicle and the moving person are predicted to be at a closest approach, and an attention calling unit for determining whether or not to perform attention calling to the moving person based on the closest approach distance.

The approach monitoring system may have a configuration in which the attention calling unit performs the attention calling to the moving person at a time when the closest approach distance is equal to or less than a predetermined judgment distance.

The approach monitoring system may have a configuration that includes a judgment distance setting unit for setting the judgment distance to be longer as a moving velocity of the moving person increases.

The approach monitoring system may have a configuration that includes a judgment distance setting unit for setting the judgment distance so a time of dividing the judgment distance by a moving velocity of the moving person becomes a first predetermined time.

The approach monitoring system may have a configuration that includes a moving person attribute recognition unit for recognizing an attribute of the moving person, and a judgment distance setting unit for setting the judgment distance based on the attribute of the moving person.

The approach monitoring system may have a configuration in which the attention calling unit starts the attention calling a second predetermined time before the closest approach time, and the second predetermined time is set to be longer than a time of dividing the judgment distance by a moving velocity of the moving person.

The approach monitoring system may have a configuration in which the attention calling unit performs the attention calling to the moving person at a time when a time of dividing the closest approach distance by a moving velocity of the moving person is equal to or less than a first predetermined time.

The approach monitoring system may have a configuration in which the attention calling unit changes a state of the attention calling in accordance with a reduction in a remaining time until the closest approach time.

The approach monitoring system may have a configuration that includes a protective fence presence or absence recognition unit for recognizing a presence or absence of a protective fence that partitions a traveling area of the vehicle and a moving area of the moving person, in which the attention calling unit does not perform the attention calling in a case where the vehicle is traveling in a traveling area recognized as having the protective fence by the protective fence presence or absence recognition unit.

As a second aspect for achieving the objective, an approach monitoring method executed by a computer is provided, the approach monitoring method including a moving person detection step of detecting a moving person present in a periphery of a vehicle, a vehicle prediction route recognition step of recognizing a vehicle prediction route being a prediction route of the vehicle, a moving person prediction route recognition step of recognizing a moving person prediction route being a prediction route of the moving person, a closest approach distance calculation step of calculating a closest approach distance in the vehicle prediction route and the moving person prediction route in a case where the vehicle prediction route and the moving person prediction route do not overlap, the closest approach distance being a distance between the vehicle and the moving person at a closest approach time being a time when the vehicle and the moving person are predicted to be at a closest approach, and an attention calling step of determining whether or not to perform attention calling to the moving person based on the closest approach distance.

As a third aspect for achieving the objective, an approach monitoring program is provided, the approach monitoring program for causing a computer to function as a moving person detection unit for detecting a moving person present in a periphery of a vehicle, a vehicle prediction route recognition unit for recognizing a vehicle prediction route being a prediction route of the vehicle, a moving person prediction route recognition unit for recognizing a moving person prediction route being a prediction route of the moving person, a closest approach distance calculation unit for calculating a closest approach distance in the vehicle prediction route and the moving person prediction route in a case where the vehicle prediction route and the moving person prediction route do not overlap, the closest approach distance being a distance between the vehicle and the moving person at a closest approach time being a time when the vehicle and the moving person are predicted to be at a closest approach, and an attention calling unit for determining whether or not to perform attention calling to the moving person based on the closest approach distance.

### Advantageous Effect of Invention

According to the approach monitoring system, the approach monitoring method, and the approach monitoring program, contact between a vehicle and a moving person can be prevented in advance, while suppressing a feeling of annoyance by the moving person, the contact between the vehicle and the moving person being due to a sudden change in behavior of the moving person present in a periphery of the vehicle.

### BRIEF DESCRIPTION OF THE DRAWINGS

FIG. 1 is a configuration diagram of an approach monitoring system;

FIG. 2 is an explanation diagram of a timing of attention calling in a case where a vehicle prediction route and a moving person prediction route do not overlap;

FIG. 3 is an explanation diagram of a timing of attention calling in a case where a vehicle prediction route and a moving person prediction route overlap;

FIG. 4 is a first flowchart of an approach monitoring process;

FIG. 5 is a second flowchart of an approach monitoring process; and

FIG. 6 is a third flowchart of an approach monitoring process.

### DETAILED DESCRIPTION OF THE INVENTION

### [1. Configuration of Approach Monitoring System]

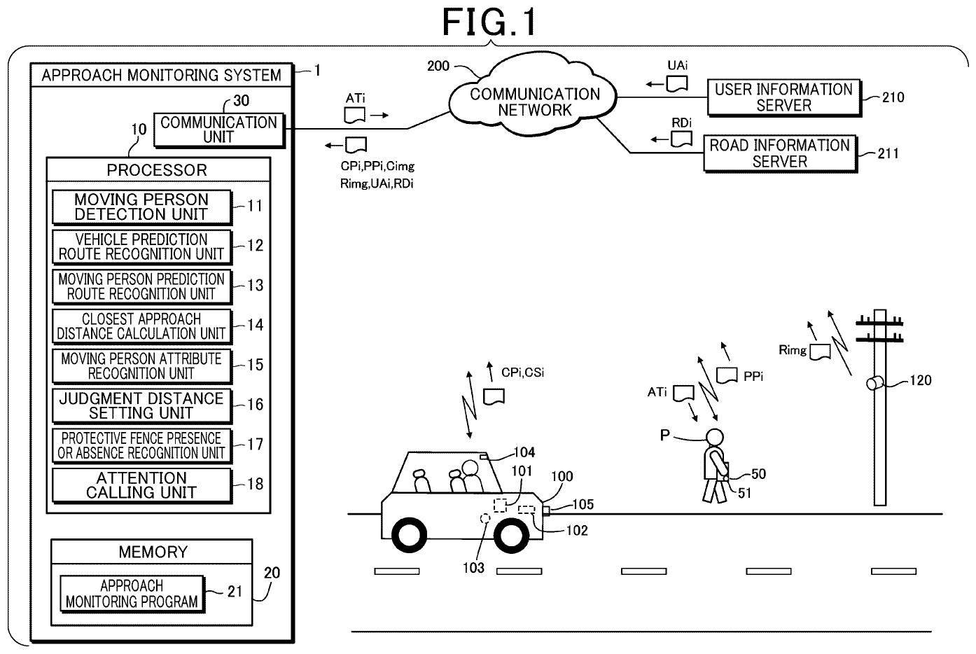

A configuration of an approach monitoring system 1 of the present disclosure will be described, with reference to FIG. 1 to FIG. 3. As shown in FIG. 1, the approach monitoring system 1 is a computer system configured by a processor 10, a memory 20, a communication unit 30 and the like, and the approach monitoring system 1 performs attention calling to a moving person, by monitoring an approach between a vehicle 100 traveling on a road and the moving person moving on the road.

In FIG. 1 to FIG. 3, a pedestrian P is exemplified as the moving person. Other than a pedestrian, a person moving to get on a non-motorized vehicle such as a bicycle or a kickboard is included for the moving person. The approach monitoring system 1 performs communication, by the communication unit 30 having a transmitter and a receiver, between the vehicle 100, a communication terminal 50 used by the pedestrian P, a user information server 210, a road information server 211, and a monitoring camera 120 installed on the road side, via a communication network 200. The user information server 210 provides attribute information UAi that indicates attributes (age, gender and the like) of a user (including the pedestrian P) of the communication terminal 50. The road information server 211 provides road information RDi that indicates road specifications (type, traffic lane, presence or absence of a partition fence such as a guard rail and the like).

The vehicle 100 includes an ECU (Electronic Control Unit) that controls operations of the vehicle 100, a communication unit 102 that performs communication via the communication network 200, a GNSS (Global Navigation Satellite System) sensor 103 that detects a present position of the vehicle 100, a front camera 104 that photographs the front of the vehicle 100, and a front radar 105 that detects a position of an object present in front of the vehicle 100.

The ECU 101 transmits vehicle position information CPi to the approach monitoring system 1, the vehicle position information CPi indicating a present position of the vehicle 100 detected by the GNSS sensor 103, and the ECU 101 transmits vehicle periphery information CSi to the approach monitoring system 1, the vehicle periphery information CSi indicating a situation of a periphery of the vehicle 100 recognized from a photographed image of the front camera 104 and a detection signal of the front radar 105. The communication terminal 50 has a GNSS sensor 51, and the communication terminal 50 transmits moving person position information PPi to the approach monitoring system 1, the moving person position information PPi indicating a present position of the pedestrian P detected by the GNSS sensor 51. The monitoring camera 120 transmits a road image Rimg to the approach monitoring system 1, the road image Rimg photographing a peripheral road.

An approach monitoring program 21 is stored in the memory 20 of the approach monitoring system 1. The approach monitoring program 21 may be stored in the memory 20 by being read by the approach monitoring system 1 from a recording medium (optical disk, magnetic disk, semiconductor memory or the like), or the approach monitoring program 21 may be stored in the memory 20 by being downloaded by the approach monitoring system 1 from an external server. The processor 10 functions as a moving person detection unit 11, a vehicle prediction route recognition unit 12, a moving person prediction route recognition unit 13, a closest approach distance calculation unit 14, a moving person attribute recognition unit 15, a judgment distance setting unit 16, a protective fence presence or absence recognition unit 17, and an attention calling unit 18, by reading and executing the approach monitoring program 21.

A process executed by the moving person detection unit 11 corresponds to a moving person detection step in the approach monitoring method of the present disclosure, and a process executed by the vehicle prediction route recognition unit 12 corresponds to a vehicle prediction route recognition step in the approach monitoring method of the present disclosure. A process executed by the moving person prediction route recognition unit 13 corresponds to a moving person prediction route recognition step in the approach monitoring method of the present disclosure, and a process executed by the closest approach distance calculation unit 14 corresponds to a closest approach distance calculation step in the approach monitoring method of the present disclosure. A process executed by the attention calling unit 18 corresponds to an attention calling step in the approach monitoring method of the present disclosure.

The moving person detection unit 11 detects a moving person present in a front periphery of the vehicle 100, based on the vehicle position information CPi and the vehicle periphery information CSi transmitted from the vehicle 100, the moving person position information PPi transmitted from the communication terminal 50 possessed by the pedestrian P, and the road image Rimg transmitted from the monitoring camera 120. In the example of FIG. 1, the moving person detection unit 11 detects the pedestrian P in front of the vehicle 100. Note that, the moving person detection unit 11 may detect a moving person present in a front periphery of the vehicle 100, by using only the vehicle position information CPi and the moving person position information PPi, for example, and not all of these pieces of information.

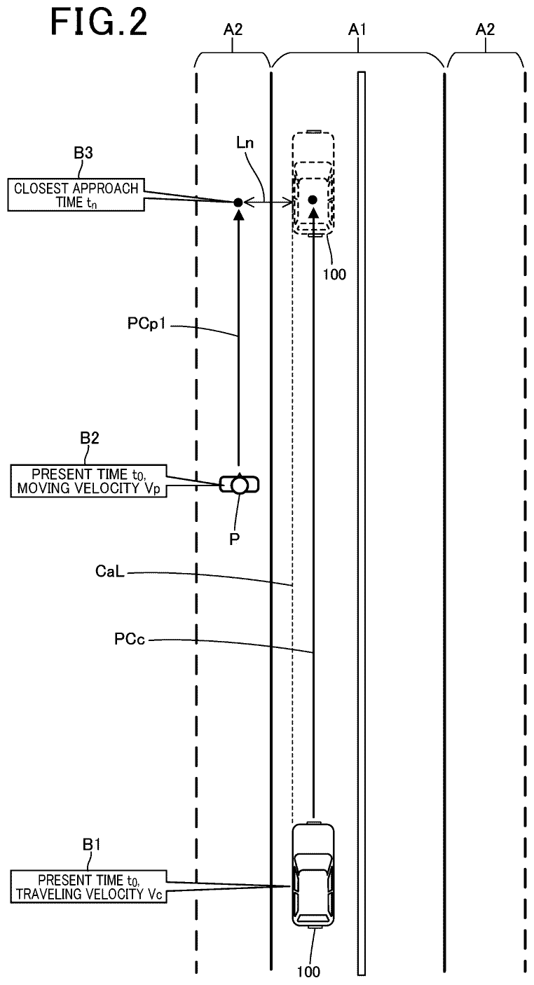

The vehicle prediction route recognition unit 12 recognizes a vehicle prediction route PCc, based on a transition of the position of the vehicle 100 recognized from the vehicle position information CPi, the vehicle prediction route PCc being a prediction route of the vehicle 100 at a present time to, as shown by speech bubble B1 of FIG. 2. CaL of FIG. 2 shows a left-end position of the vehicle 100. A1 of FIG. 2 is a roadway on which the vehicle 100 travels, and A2 is a sidewalk on which the pedestrian P moves.

The moving person prediction route recognition unit 13 recognizes a moving person prediction route PCp1, based on a transition of the position of the pedestrian P recognized from the moving person position information PPi, the moving person prediction route PCp1 being a prediction route of the pedestrian P at a present time to, as shown by speech bubble B2 of FIG. 2. The closest approach distance calculation unit 14 calculates a distance (closest approach distance) Ln between the vehicle 100 and the pedestrian P at a time (closest approach time) tn when the vehicle 100 and the pedestrian P approach closest to one another, the time tn being shown by speech bubble B3, in the vehicle prediction route PCc1 and the moving person prediction route PCp, as shown in FIG. 2.

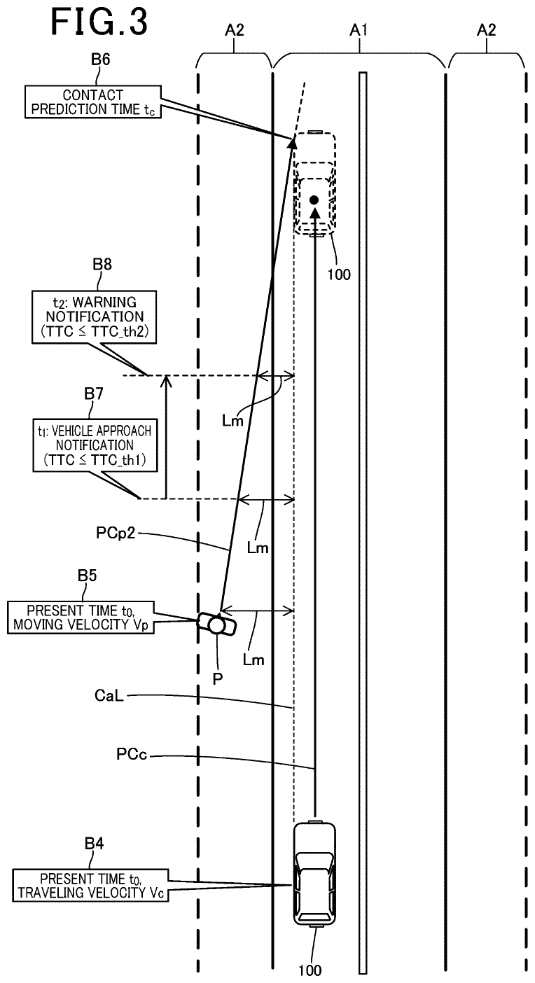

FIG. 2 exemplifies a case in which the vehicle prediction route PCc and the moving person prediction route PCp1 do not overlap, and FIG. 3 exemplifies a case in which the vehicle prediction route PCc and the moving person prediction route PCp2 overlap (intersect). In FIG. 3, the vehicle prediction route PCc for the vehicle 100 at a present time to is recognized by the vehicle prediction route recognition unit 12, as shown by speech bubbler B4, and a moving person prediction route PCp2 for the pedestrian P at a present time to is recognized by the moving person prediction route recognition unit 13, as shown by speech bubble B5.

The moving person attribute recognition unit 15 recognizes an attribute of the pedestrian P, by accessing the user information server 210 to acquire the attribute information UAi related to the pedestrian P, or the moving person attribute recognition unit 15 recognizes an attribute of the pedestrian P, from an image of the pedestrian P by the front camera 104 included in the vehicle periphery information CSi or an image of the pedestrian P included in the road image Rimg. The judgment distance setting unit 16 sets a judgment distance Lth for judging whether or not to perform attention calling for an approach of the vehicle 100 to the pedestrian P.

The judgment distance setting unit 16 recognizes a moving velocity Vp of the pedestrian P, based on a change in position of the pedestrian P recognized from the moving person position information PPi, as shown by speech bubble B2, in FIG. 2. Also, the judgment distance setting unit 16 calculates the judgment distance Lth by the following Equation (1). According to the following Equation (1), the judgment distance Lth is set to be longer as the moving velocity Vp of the pedestrian P increases. Moreover, the judgment distance setting unit 16 performs a correction that sets the judgment distance Lth to be longer than a reference distance assumed for an adult, at the time when the pedestrian P is recognized as being a child and at the time when the pedestrian P is recognized as being elderly, from an attribute of the pedestrian P recognized by the moving person attribute recognition unit 15.

$$Lth / Vp = Tth 1 \qquad ( 1 )$$

Here, Lth is the judgment distance, Vp is the moving velocity of the pedestrian P, and Tth1 is a first predetermined time.

The first predetermined time Tth1 is set to several seconds, for example, based on an assumed time until a general pedestrian stops from a time when the general pedestrian receives attention calling during walking (an assumed time until a pedestrian jumping out onto the roadway stops by receiving attention calling).

The protective fence presence or absence recognition unit 17 recognizes a presence or absence of a protective fence that partitions the roadway A1 and the sidewalk A2, by accessing the road information server 211 to acquire the road information RDi, or the protective fence presence or absence recognition unit 17 recognizes a presence or absence of a protective fence that partitions the roadway A1 and the sidewalk A2, by searching for an image portion of a protective fence from an image of a road by the front camera 104 included in the vehicle periphery information CSi or the road image Rimg by the monitoring camera 120. The protective fence is, for example, a guard rail, a fence or the like.

The attention calling unit 18 performs attention calling to the pedestrian P, at the time when there is a high possibility of the vehicle 100 and the pedestrian P approaching each other. A detailed description of the process of attention calling will be described below.

### [2. Approach Monitoring Process]

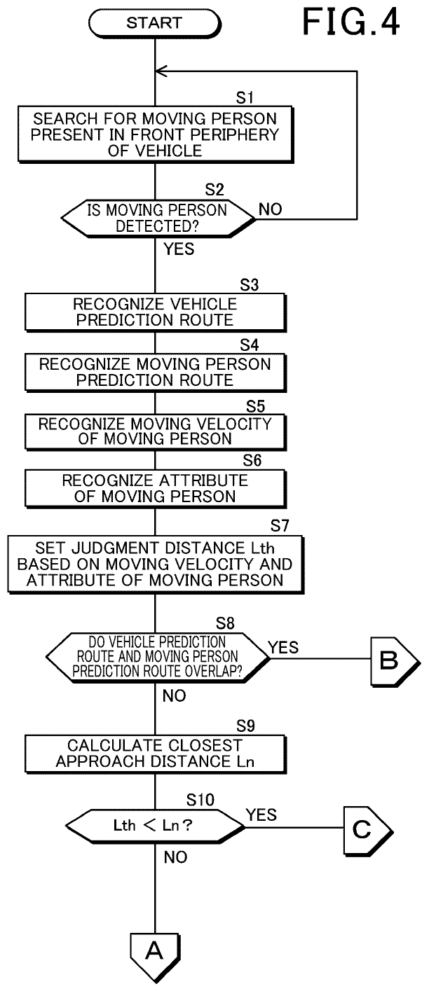

The procedures of an approach monitoring process executed by the approach monitoring system 1, in the situation shown in FIG. 1 to FIG. 3, will be described in accordance with the flowcharts shown in FIG. 4 to FIG. 6. The approach monitoring system 1 repeatedly executes the processes by the flowcharts shown in FIG. 4 to FIG. 6.

In step S1 of FIG. 4, the moving person detection unit 11 searches for a moving person present in a front periphery of the vehicle 100. To continue, in step S2, the moving person detection unit 11 proceeds with the process to step S3 at the time when a moving person is detected, and the moving person detection unit 11 proceeds with the process to step S1 at the time when a moving person is not detected. In the examples of FIG. 1 to FIG. 3, the moving person detection unit 11 proceeds with the process to step S3 by detecting the pedestrian P.

In step S3, the vehicle prediction route recognition unit 12 recognizes the vehicle prediction route PCc for the vehicle 100, as shown in FIG. 2 and FIG. 3. To continue, in step S4, the moving person prediction route recognition unit 13 recognizes the moving person prediction route PCp (PCp1 in FIG. 2, PCp2 in FIG. 3) for the pedestrian P. Next, in step S5, the judgment distance setting unit 16 recognizes the moving velocity Vp of the pedestrian P (moving person). To continue, in step S6, the moving person attribute recognition unit 15 recognizes an attribute of the pedestrian P.

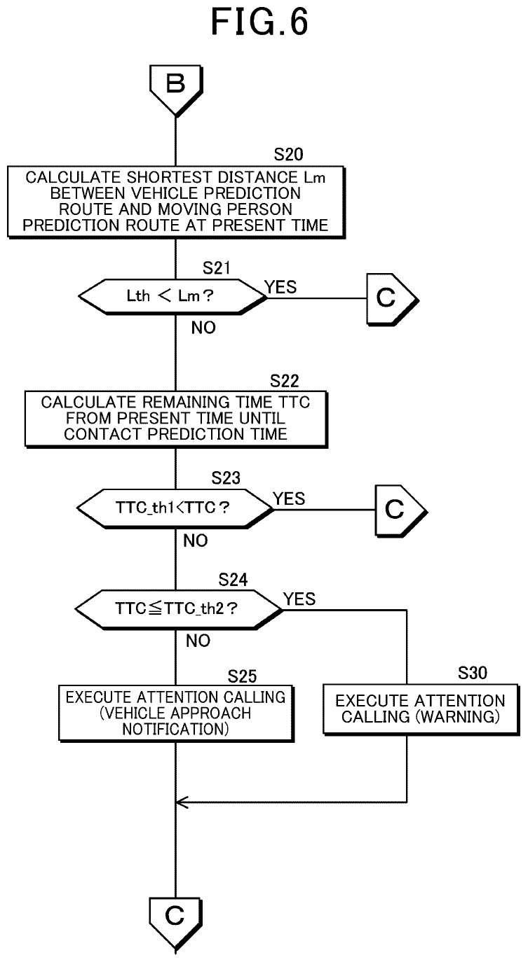

Next, in step S7, the judgment distance setting unit 16 sets the judgment distance Lth such as stated above, based on the moving velocity Vp and the attribute of the pedestrian P. To continue, in step S8, the attention calling unit 18 determines whether or not the vehicle prediction route PCc and the moving person prediction route PCp overlap. Then, in a case where the vehicle prediction route PCc and the moving person prediction route PCp overlap (the case of FIG. 3), the attention calling unit 18 proceeds with the process to step S20 of FIG. 6, and in a case where the vehicle prediction route PCc and the moving person prediction route PCp do not overlap (the case of FIG. 2), the attention calling unit 18 proceeds with the process to step S9.

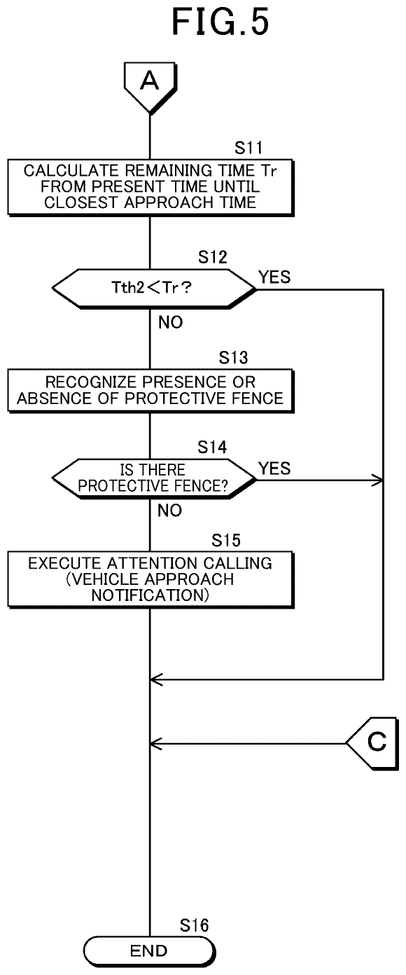

In step S9, the closest approach distance calculation unit 14 calculates the closest approach distance Ln as shown in FIG. 2. To continue, in step S10, the attention calling unit 18 determines whether or not the closest approach distance In exceeds the judgment distance Lth. Then, the attention calling unit 18 proceeds with the process to step S16 of FIG. 6 at the time when the closest approach distance Ln exceeds the judgment distance Lth, and in this case, attention calling to the pedestrian P is not performed. On the other hand, at the time when the closest approach distance Ln is equal to or less than the judgment distance Lth, the attention calling unit 18 proceeds with the process to step S11 of FIG. 5.

In step S11, the attention calling unit 18 calculates a remaining time Tr from a present time until a closest approach time. To continue, in step S12, the attention calling unit 18 determines whether or not the remaining time Tr is longer than a second predetermined time Tth2. Then, the attention calling unit 18 proceeds with the process to step S16 when the remaining time Tr is longer than the second predetermined time Tth2, and in this case, attention calling to the pedestrian P is not performed. On the other hand, at the time when the remaining time Tr is equal to or less than the second predetermined time Tth2, the attention calling unit 18 proceeds with the process to step S13. The second predetermined time Tth2 is set so that the relationship of the following Equation (2) is established.

$$Tth 2 > Lth / Vp \qquad ( 2 )$$

Here, Tth2 is the second predetermined time, Lth is the judgment distance, and Vp is the moving velocity of the pedestrian P.

In step S13, the protective fence presence or absence recognition unit 17 recognizes a presence or absence of a protective fence that partitions the roadway A1 and the sidewalk A2. To continue, in step S14, at the time when it is recognized that there is a protective fence by the protective fence presence or absence recognition unit 17, the attention calling unit 18 proceeds with the process to step S16, and in this case, attention calling to the pedestrian P is not performed. On the other hand, at the time when it is recognized that there is no protective fence by the protective fence presence or absence recognition unit 17, the attention calling unit 18 proceeds with the process to step S15.

In step S15, the attention calling unit 18 transmits attention calling information ATi to the communication terminal 50 possessed by the pedestrian P, as shown in FIG. 1, as attention calling to the pedestrian P, the attention calling information ATi notifying the fact that the vehicle 100 is approaching. The communication terminal 50 receiving the attention calling information ATi outputs an alarm sound, and the communication terminal 50 receiving the attention calling information ATi displays an image on a display unit, the image notifying the fact that the vehicle 100 is approaching. In this way, by urging attention to the vehicle 100 for the pedestrian P, the pedestrian P making contact with the vehicle 100 can be prevented in advance, at the time when the pedestrian P jumps out onto the roadway. In this case, the intensity of attention calling may by increased by performing a process such as increasing the alarm sound, for example, as the remaining time Tr becomes shorter.

FIG. 6 is a process corresponding to a case where the vehicle prediction route PCc for the vehicle 100 and the moving person prediction route PCp2 for the pedestrian P overlap, as shown in FIG. 3. In step S20 of FIG. 6, the attention calling unit 18 calculates a shortest distance Lm between the vehicle prediction route PCc and the moving person prediction route PCp2 at a present time (refer to FIG. 3). The shortest distance Lm becomes shorter in accordance with the progress of the vehicle 100 and the pedestrian P.

To continue, in step S21, the attention calling unit 18 determines whether or not the shortest distance Lm exceeds the judgment distance Lth. Then, at the time when the shortest distance Im exceeds the judgment distance Lth, the attention calling unit 18 proceeds with the process to step S16 of FIG. 5, and in this case, attention calling to the pedestrian P is not performed. On the other hand, at the time when the shortest distance Lm is equal to or less than the judgment distance Lth, the attention calling unit 18 proceeds with the process to step S22.

In step S22, the attention calling unit 18 calculates a remaining time TTC until a contact prediction time tc, from a present time, as shown in FIG. 3, the contact prediction time tc being a time when a left-end line CaL corresponding to the vehicle prediction route PCc and the moving person prediction route PCp2 overlap (intersect), as shown by speech bubble B6. To continue, in step S23, the attention calling unit 18 determines whether or not the remaining time TTC exceeds a first judgment time TTC th1.

Then, in a case where the remaining time TTC exceeds the first judgment time TTC_th1, the attention calling unit 18 proceeds with the process to step S16 of FIG. 5, and in this case, attention calling to the pedestrian P is not performed. On the other hand, at the time when the remaining time TTC is equal to or less than the first judgment time TTC_th1, the attention calling unit 18 proceeds with the process to step S24.

In step S24, the attention calling unit 18 determines whether or not the remaining time TTC is equal to or less than a second judgment time TTC_th2 (<TTC_th2). Then, at the time when the remaining time TTC is equal to or less than the second judgment time TTC th2, the attention calling unit 18 proceeds with the process to step S30, and at the time when the remaining time TTC is longer than the second judgment time TTC_th2, the attention calling unit 18 proceeds with the process to step S25.

In step S25, the attention calling unit 18 transmits the attention calling information ATi to the communication terminal 50 possessed by the pedestrian P, the attention calling information ATi notifying an approach of the vehicle 100, as shown by speech bubble B7 of FIG. 3. The communication terminal 50 receiving the attention calling information ATi outputs an alarm sound notifying the fact that the vehicle 100 is approaching, and the communication terminal 50 receiving the attention calling information ATi displays an image on a display unit, the image notifying the fact that the vehicle 100 is approaching. In this way, by urging attention to the vehicle 100 for the pedestrian P, the pedestrian P proceeding in a direction of contact with the vehicle 100 without change, and the pedestrian P and the vehicle 100 making contact, can be prevented in advance.

In step S25, the attention calling unit 18 transmits the attention calling information ATi to the communication terminal 50 possessed by the pedestrian P, at t2 when the remaining time TTC is equal to or less than the second judgment time TTC_th2, as shown by speech bubble B8 of FIG. 3, the attention calling information ATi warning an approach of the vehicle 100. The communication terminal 50 receiving the attention calling information ATi outputs an alarm sound warning that the vehicle 100 is coming near, and the communication terminal 50 receiving the attention calling information ATi displays an image on a display unit, the image notifying the fact that the vehicle 100 is coming near. In this way, by urging progress to stop for the pedestrian P, the pedestrian P and the vehicle 100 making contact can be prevented in advance.

### 3. Other Embodiments

In the above embodiment, while the judgment distance Lth is set in accordance with the moving velocity Vp of the pedestrian P, by including the judgment distance setting unit 16, the judgment distance Lth being used for a determination of whether or not to perform attention calling to the pedestrian P, the judgment distance Lth may be set to a fixed value, by omitting the judgment distance setting unit 16.

In the above embodiment, while the judgment distance setting unit 16 sets the judgment distance Lth, based on an attribute of the pedestrian P, by including the moving person attribute recognition unit 15, the judgment distance setting unit 16 may be configured so that a setting of the judgment distance Lth is not performed based on an attribute of the pedestrian P, by omitting the moving person attribute recognition unit 15.

In the above embodiment, attention calling to the pedestrian P is not performed by the attention calling unit 18, in a case where there is a protective fence that partitions the roadway A1 and the sidewalk A2, by including the protective fence presence or absence recognition unit 17. As another embodiment, the attention calling unit 18 may be configured to not perform a determination of whether or not to perform attention calling by a presence or absence of a protective fence, by omitting the protective fence presence or absence recognition unit 17.

In the above embodiment, the attention calling unit 18 performs attention calling to the pedestrian P, at the time when it is determined that a closest approach distance Ln in step S10 of FIG. 4 is equal to or less than the judgment distance Lth. As another embodiment, the attention calling unit 18 may perform attention calling to the pedestrian P, at the time when the condition of the following Equation (3) is established.

$$L n / Vp <= Tth 1 \qquad ( 3 )$$

Here, Ln is the closest approach distance, Vp is the moving velocity of the pedestrian P, and Tth1 is a first predetermined time (refer to Equation (1)).

Note that, FIG. 1 is a schematic diagram showing the configuration of the approach monitoring system 1 divided by the main process contents, in order to facilitate understanding of the present application invention, and the configuration of the approach monitoring system 1 may be a configuration divided in another manner. Moreover, the processes of each constituent element may be executed by one hardware unit, or the processes of each constituent element may be executed by a plurality of hardware units. Moreover, the processes by each of the constituent elements shown in FIG. 4 to FIG. 6 may be executed by one program, or the processes by each of the constituent elements shown in FIG. 4 to FIG. 6 may be executed by a plurality of programs.

### 4. Configurations Supported by the Embodiments

The above-stated embodiments are specific examples of the following configurations.

(Configuration 1) An approach monitoring system including a moving person detection unit for detecting a moving person present in a periphery of a vehicle, a vehicle prediction route recognition unit for recognizing a vehicle prediction route being a prediction route of the vehicle, a moving person prediction route recognition unit for recognizing a moving person prediction route being a prediction route of the moving person, a closest approach distance calculation unit for calculating a closest approach distance in the vehicle prediction route and the moving person prediction route in a case where the vehicle prediction route and the moving person prediction route do not overlap, the closest approach distance being a distance between the vehicle and the moving person at a closest approach time being a time when the vehicle and the moving person are predicted to be at a closest approach, and an attention calling unit for determining whether or not to perform attention calling to the moving person based on the closest approach distance.

According to the approach monitoring system of Configuration 1, contact between a vehicle and a moving person due to a sudden change in behavior of the moving person present in a periphery of the vehicle can be prevented in advance, while suppressing a feeling of annoyance by the moving person. A pedestrian, and a person moving to get on a non-motorized vehicle such as a bicycle or a kickboard are included for the moving person.

(Configuration 2) The approach monitoring system described in Configuration 1, in which the attention calling unit performs the attention calling to the moving person at a time when the closest approach distance is equal to or less than a predetermined judgment distance.

According to the approach monitoring system of Configuration 2, whether or not to perform attention calling can be determined, in accordance with a judgment distance.

(Configuration 3) The approach monitoring system described in Configuration 2, further including a judgment distance setting unit for setting the judgment distance to be longer as a moving velocity of the moving person increases.

According to the approach monitoring system of Configuration 3, since a moving direction of a moving person quickly changes to a direction toward a vehicle as a moving velocity of the moving person increases, and thereafter it is predicted that a time until the moving person makes contact with the vehicle becomes shorter, attention calling for avoiding contact can be performed with plenty of time, by setting a judgment distance to be longer as the moving velocity of the moving person increases.

(Configuration 4) The approach monitoring system described in Configuration 2, further including a judgment distance setting unit for setting the judgment distance so a time of dividing the judgment distance by a moving velocity of the moving person becomes a first predetermined time.

According to the approach monitoring system of Configuration 4, when assuming a case in which a moving direction of a moving person changes to a direction toward a vehicle, attention calling can be performed in a case where a prediction time until the moving person makes contact with the vehicle becomes equal to or less than a first predetermined time.

(Configuration 5) The approach monitoring system described in Configuration 2, further including a moving person attribute recognition unit for recognizing an attribute of the moving person, and a judgment distance setting unit for setting the judgment distance based on the attribute of the moving person.

According to the approach monitoring system of Configuration 5, a judgment distance suitable for a moving person can be set, in accordance with a behavioral characteristic, reaction speed, agility or the like of the moving person estimated from an attribute of the moving person.

(Configuration 6) The approach monitoring system described in any one of Configuration 2 to Configuration 5, in which the attention calling unit starts the attention calling a second predetermined time before the closest approach time, and the second predetermined time is set to be longer than a time of dividing the judgment distance by a moving velocity of the moving person.

According to the approach monitoring system of Configuration 6, even when a moving direction of a moving person changes to a direction toward a vehicle, a predetermined time can be set so that a time that allows avoiding contact between the vehicle and the moving person is secured, by having the moving person stop movement in the direction toward the vehicle, by attention calling.

(Configuration 7) The approach monitoring system described in Configuration 1, in which the attention calling unit performs the attention calling to the moving person at a time when a time of dividing the closest approach distance by a moving velocity of the moving person is equal to or less than a first predetermined time.

According to the approach monitoring system of Configuration 7, whether or not to perform attention calling can be determined, in accordance with a first predetermined time.

(Configuration 8) The approach monitoring system described in any one of Configuration 1 to Configuration 7, in which the attention calling unit changes a state of the attention calling in accordance with a reduction in a remaining time until the closest approach time.

According to the approach monitoring system of Configuration 8, the possibility of contact with a vehicle being raised for a moving person can be recognized, by a change in the state of attention calling.

(Configuration 9) The approach monitoring system described in any one of Configuration 1 to Configuration 8, further including a protective fence presence or absence recognition unit for recognizing a presence or absence of a protective fence that partitions a traveling area of the vehicle and a moving area of the moving person, in which the attention calling unit does not perform the attention calling in a case where the vehicle is traveling in a traveling area recognized as having the protective fence by the protective fence presence or absence recognition unit.

According to the approach monitoring system of Configuration 9, wasteful attention calling being performed to a moving person can be avoided at a time of a situation where the moving person moving in a direction toward a vehicle is hindered by the presence of a protective fence.

(Configuration 10) An approach monitoring method executed by a computer, the approach monitoring method including a moving person detection step of detecting a moving person present in a periphery of a vehicle, a vehicle prediction route recognition step of recognizing a vehicle prediction route being a prediction route of the vehicle, a moving person prediction route recognition step of recognizing a moving person prediction route being a prediction route of the moving person, a closest approach distance calculation step of calculating a closest approach distance in the vehicle prediction route and the moving person prediction route in a case where the vehicle prediction route and the moving person prediction route do not overlap, the closest approach distance being a distance between the vehicle and the moving person at a closest approach time being a time when the vehicle and the moving person are predicted to be at a closest approach, and an attention calling step of determining whether or not to perform attention calling to the moving person based on the closest approach distance.

An action effect similar to the action effect of the approach monitoring system of Configuration 1 can be obtained, by executing the approach monitoring method of Configuration 10 by a computer.

(Configuration 11) An approach monitoring program for causing a computer to function as a moving person detection unit for detecting a moving person present in a periphery of a vehicle, a vehicle prediction route recognition unit for recognizing a vehicle prediction route being a prediction route of the vehicle, a moving person prediction route recognition unit for recognizing a moving person prediction route being a prediction route of the moving person, a closest approach distance calculation unit for calculating a closest approach distance in the vehicle prediction route and the moving person prediction route in a case where the vehicle prediction route and the moving person prediction route do not overlap, the closest approach distance being a distance between the vehicle and the moving person at a closest approach time being a time when the vehicle and the moving person are predicted to be at a closest approach, and an attention calling unit for determining whether or not to perform attention calling to the moving person based on the closest approach distance.

The configuration of the approach monitoring system of Configuration 1 can be implemented, by executing the approach monitoring program of Configuration 11 by a computer.

### REFERENCE SIGNS LIST

1 approach monitoring system
10 processor
11 moving person detection unit
12 vehicle prediction route recognition unit
13 moving person prediction route recognition unit
14 closest approach distance calculation unit
15 moving person attribute recognition unit
16 judgment distance setting unit
17 protective fence presence or absence recognition unit
18 attention calling unit
20 memory
21 approach monitoring program
50 communication terminal
51 GNSS sensor
100 vehicle
101 ECU
102 communication unit
103 GNSS sensor
104 front camera
105 front radar
120 monitoring camera
200 communication network
210 user information server
211 road information server
P pedestrian
PCc vehicle prediction route
PCp1, PCp2 moving person prediction route
Ln closest approach distance

1. An approach monitoring system comprising:
a moving person detection unit for detecting a moving person present in a periphery of a vehicle;
a vehicle prediction route recognition unit for recognizing a vehicle prediction route being a prediction route of the vehicle;
a moving person prediction route recognition unit for recognizing a moving person prediction route being a prediction route of the moving person;
a closest approach distance calculation unit for calculating a closest approach distance in the vehicle prediction route and the moving person prediction route in a case where the vehicle prediction route and the moving person prediction route do not overlap, the closest approach distance being a distance between the vehicle and the moving person at a closest approach time being a time when the vehicle and the moving person are predicted to be at a closest approach; and
an attention calling unit for determining whether or not to perform attention calling to the moving person based on the closest approach distance.

2. The approach monitoring system according to claim 1, wherein
the attention calling unit performs the attention calling to the moving person at a time when the closest approach distance is equal to or less than a predetermined judgment distance.

3. The approach monitoring system according to claim 2, further comprising:
a judgment distance setting unit for setting the judgment distance to be longer as a moving velocity of the moving person increases.

4. The approach monitoring system according to claim 2, further comprising:
a judgment distance setting unit for setting the judgment distance so a time of dividing the judgment distance by a moving velocity of the moving person becomes a first predetermined time.

5. The approach monitoring system according to claim 2, further comprising:
a moving person attribute recognition unit for recognizing an attribute of the moving person; and
a judgment distance setting unit for setting the judgment distance based on the attribute of the moving person.

6. The approach monitoring system according to claim 2, wherein
the attention calling unit starts the attention calling a second predetermined time before the closest approach time, and
the second predetermined time is set to be longer than a time of dividing the judgment distance by a moving velocity of the moving person.

7. The approach monitoring system according to claim 1, wherein
the attention calling unit performs the attention calling to the moving person at a time when a time of dividing the closest approach distance by a moving velocity of the moving person is equal to or less than a first predetermined time.

8. The approach monitoring system according to claim 1, wherein
the attention calling unit changes a state of the attention calling in accordance with a reduction in a remaining time until the closest approach time.

9. The approach monitoring system according to claim 1, further comprising:
a protective fence presence or absence recognition unit for recognizing a presence or absence of a protective fence that partitions a traveling area of the vehicle and a moving area of the moving person, wherein
the attention calling unit does not perform the attention calling in a case where the vehicle is traveling in a traveling area recognized as having the protective fence by the protective fence presence or absence recognition unit.

10. An approach monitoring method executed by a computer, the approach monitoring method comprising:
a moving person detection step of detecting a moving person present in a periphery of a vehicle;
a vehicle prediction route recognition step of recognizing a vehicle prediction route being a prediction route of the vehicle;
a moving person prediction route recognition step of recognizing a moving person prediction route being a prediction route of the moving person;
a closest approach distance calculation step of calculating a closest approach distance in the vehicle prediction route and the moving person prediction route in a case where the vehicle prediction route and the moving person prediction route do not overlap, the closest approach distance being a distance between the vehicle and the moving person at a closest approach time being a time when the vehicle and the moving person are predicted to be at a closest approach; and
determining whether or not to perform attention calling to the moving person based on the closest approach distance.

11. A non-transitory computer-readable storage medium storing an approach monitoring program for causing a computer to function as:
a moving person detection unit for detecting a moving person present in a periphery of a vehicle;
a vehicle prediction route recognition unit for recognizing a vehicle prediction route being a prediction route of the vehicle;
a moving person prediction route recognition unit for recognizing a moving person prediction route being a prediction route of the moving person;
a closest approach distance calculation unit for calculating a closest approach distance in the vehicle prediction route and the moving person prediction route in a case where the vehicle prediction route and the moving person prediction route do not overlap, the closest approach distance being a distance between the vehicle and the moving person at a closest approach time being a time when the vehicle and the moving person are predicted to be at a closest approach; and
an attention calling unit for determining whether or not to perform attention calling to the moving person based on the closest approach distance.
